(19) United States
(12) Patent Application Publication
(10) Pub. No.: US 2005/0125272 A1
(43) Pub. Date: Jun. 9, 2005

(54) Method for validating software development maturity

(75) Inventor: John Hostetler, Southlake, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/040,788

(22) Filed: Jan. 20, 2005

Related U.S. Application Data
(63) Continuation-in-part of application No. 10/194,168, filed on Jul. 12, 2002.

(51) Int. Cl. G06F 17/60

(52) U.S. Cl. 705/7

(57) ABSTRACT

A validation procedure for assessing the status a software engineering process for compliance, and improving the measured compliance, with the Carnegie Mellon SEI/CMM Software Maturity Model includes a validation meeting in the course of which a validation team reviews deliverables demonstrative of the process being performed and asks a structured set of questions that are structured in accordance with the CMM and correlate with the deliverables.

### CROSS REFERENCE TO RELATED APPLICATION

This application is a continuation in part of U.S. patent application Ser. No. 10/194,168, filed on Jul. 12, 2002, of which the entirety is hereby incorporated.

### TECHNICAL FIELD

The field of the invention is that of software engineering, in particular, the validation of the status of development of a software process engineering project in conformance with the Camegie Mellon University's CMM Software Maturity Model.

### BACKGROUND OF THE INVENTION

The Capability Maturity Models (CMM) from Carnegie-Mellon Software Engineering Institute (SEI) is a well-known approach to software engineering that requires a considerable amount of overhead and is oriented toward the processes within a software development group, rather than to the level of development of a particular project.

According to the Software Engineering Institute Website: “The CMM is organized into five maturity levels:
1) Initial
2) Repeatable
3) Defined
4) Managed
5) Optimizing
   Each of these levels is further divided into sublevels. The process levels and sublevels are not linked in the sense that a process can be at level 2 in one category and at level 4 in another. Conventionally, a company will hire a certified consultant to assess its practices at a cost that typically ranges from $50,000 to $70,000.

Not only is there a considerable cash expenditure associated with the CMM Model, but the assessment process takes a substantial amount of time from the achievement of the project goals. Typically, the process will require a significant fraction of the team's resources for a month.

The SEI recommends that a project be assessed “as often as needed or required”, but the expense and time required to perform an assessment in typical fashion act as an obstacle to assessment.

Lack of knowledge of the status of an organization's maturity is a problem in carrying out the objectives of the organization and furthermore carries risks of non-compliance with the requirements of government or other customer contracts.

As the personnel involved in a project proceed, it is important that there be a validation process in which an outside entity checks that status of the project.

The art has felt a need for: a) an assessment process that is sufficiently economical and quick that it can be implemented frequently enough to guide the software development process; and b) a validation process to check that the assessment process is being followed.

### SUMMARY OF THE INVENTION

The invention relates to a method of validating the assessment by a working group of their progress in the application of a software management process implementing the CMM to a project, comprising selecting an ith level of the CMM model, selecting a jth sub-level in the ith level, selecting a KPA in the jth sub-level, reviewing the rating by the project team and a sample of deliverables associated with the KPA of the jth sub-level; and repeating the previous element for other levels and sub-levels, and then combining the ratings.

An aspect of the invention is the review of deliverables supplied by the project team for at least one sub-level.

Another aspect of the invention is the improvement of a process by selecting an ith level of the CMM model; ajth sub-level in the ith level; and assigning a rating to each KPA in the jth sub-level reflecting the level of maturity of that KPA in the project being assessed, repeating the above selecting until all KPAs in the CMM have been assessed and corresponding ratings have been made, formulating and executing a plan to improve areas with lower ratings until all areas are satisfactory; and validating the status of the process by performing from time to time a validation operation on the present status of the process.

### BRIEF DESCRIPTION OF THE DRAWINGS

FIG. 1 shows a sample of a form used in the evaluation of a software project.

FIG. 2 shows schematically the steps in evaluating a software project.

FIG. 3 shows schematically the steps in the CMM model.

FIG. 4 shows schematically the steps in applying the evaluation process to a single level of a software project.

FIG. 5 shows a validation form that may be used with the invention.

FIG. 6 shows a sequence of steps in applying the invention.

FIG. 7 shows a list of questions that may be used in the practice of the invention.

### BEST MODE OF CARRYING OUT THE INVENTION

FIG. 3 shows a frequently duplicated chart illustrating the CMM (a table of abbreviations is found at the end of the text). Within each of four levels, there are a number of topics that are to be implemented in a process according to the model. The designers of the model realized that not every project would follow every detail of the model.

Since the details of the model are not rigid, the process of assessing the compliance of procedures within a software group is not well defined.

The purpose of the procedure illustrated is to establish the process for performing software interim profile assessments or appraisals for Levels 2, 3, 4 and 5 of the CMM within software organizations. The focus is on the SEI/CMM initiative surrounding the implementation and institutionalization of project and/or organizational processes. As used in this desclosure, “Institutionalization” means the building of infrastructures and corporate culture that support methods, practices and procedures so that they are continuously verified, maintained and improved. This and other definitions are found in Table I at the end of the disclosure.

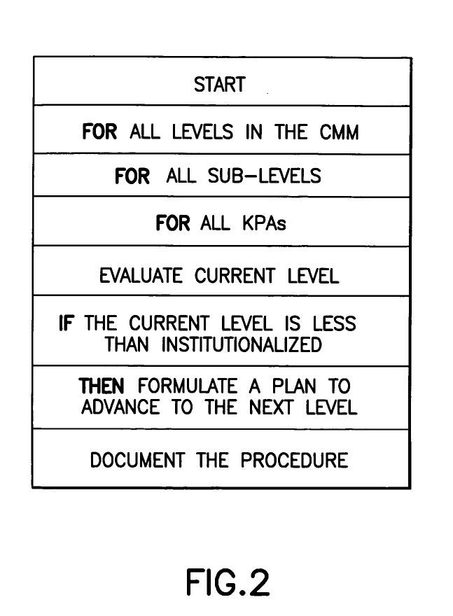

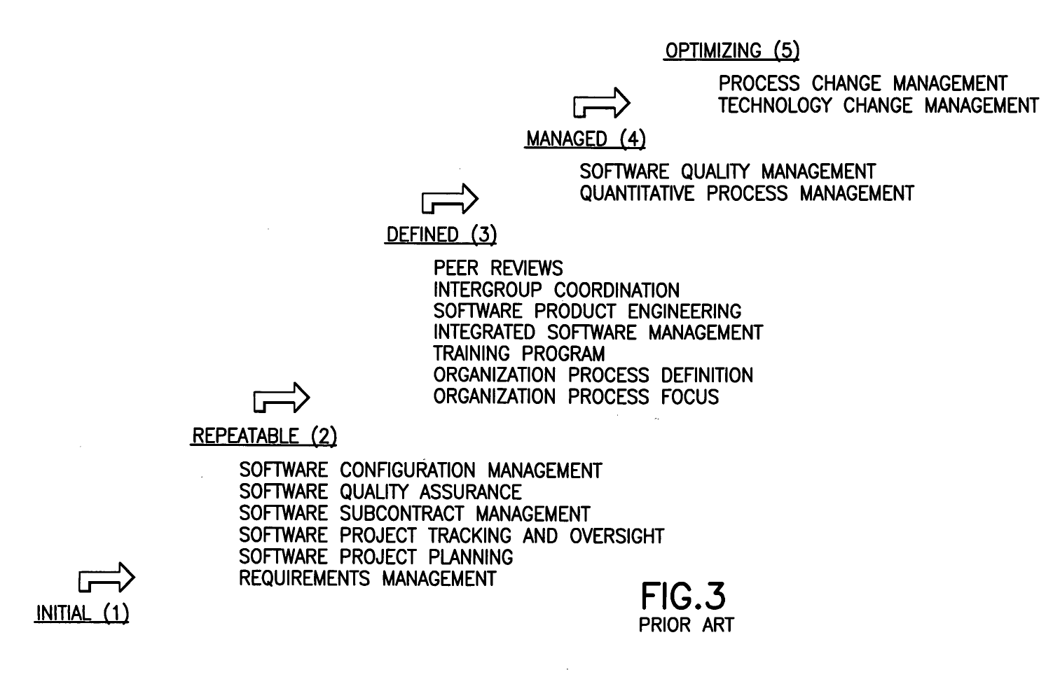

The inventive procedure is not only directed at assessment, but also at implementing improvement to the existing status. FIG. 2 illustrates in summary form the overall process, where the ratings are made on the following chart, taken from Table II below.

| | |
|---|---|
| Value | Meaning |

| | | | |
|---|---|---|---|
| | _{—} | NA | Not Applicable |
| | \| | 0 | Not Used/Not Documented |
| NS | \| | 1 | Know About |
| | \| | 2 | Documented |
| | \|_{—} | 3 | Used |
| | \| | 4 | Measured |
| PS | \| | 5 | Verified |
| | \|_{—} | 6 | Maintained |
| FS | | 7 | Continuously Improved |

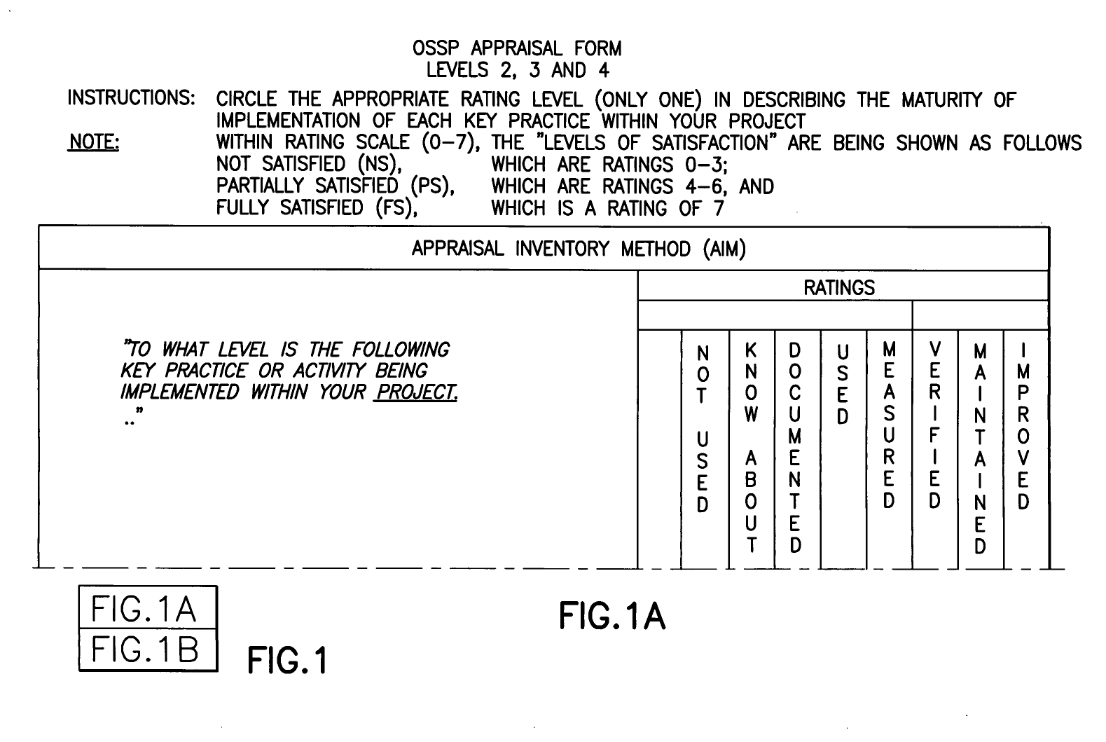

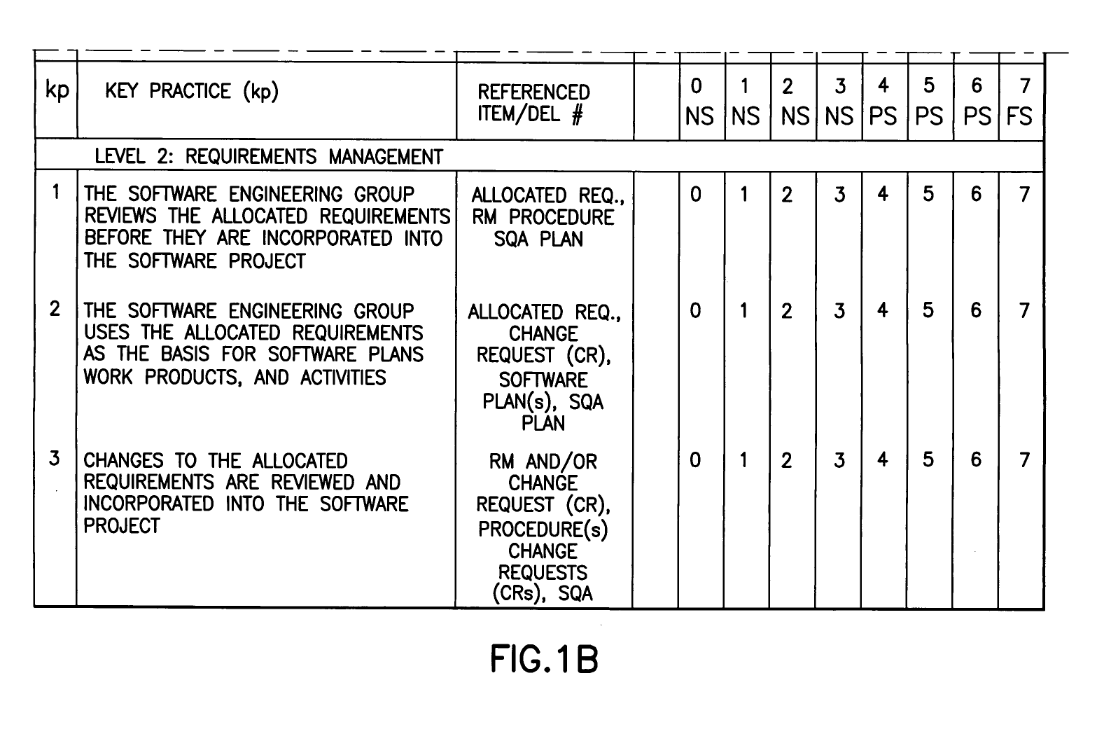

The chart is shown also in FIG. 1, illustrating a single step in assessing the lowest measured level (level 2) in the CMM. The lowest coarse level NS, for “Not Satisfied” is used for aspects that are not used in the project or are only beginning to be used. The division between the NS level and the and the intermediate level of “Partially Satisfied” is when the process is well enough developed to be measured. The first level of institutionalization starts at the next level, Verification, indicating that institutionalization requires that the process be developed sufficiently that this level of maturity has been reached. Those skilled in the art will appreciate that the particular choice of labels shown here for the levels of maturity is not essential and other sets of labels may be used that convey or express the meaning that the process is immature (Not Implemented); is fairly well along (Partially Implemented); and has reached a mature level (Fully Implemented) and the terms used in the following claims are meant to represent any equivalent label.

The process of institutionalization involves not only improving the software, but also documenting the product and the process of developing it to a degree such that the process is followed consistently, but also that it is sufficiently well documented that the departure of a single (key) person can be handled by reliance on the documentation i.e. a replacement can get up to speed in a reasonable amount of time without “re-inventing the wheel”.

This particular example has been chosen for the illustration to emphasize an aspect of the process—the lowest level of the CMM can be awarded the highest level (“Fully Institutionalized”). Using an image from geometry, it could be said that the measurement system is “orthogonal” to the CMM, meaning that, as in the previous sentence, many levels of the CMM can have different ratings. For example, the process for Inter Group coordination (on Level 3 of the CMM) might be fully institutionalized while the process for subcontracting software (on the lowest Level 2 of the CMM) might need considerable additional work. Some features of the CMM depend on other features, so that there will be some cases where ratings will also be linked, but the general rule is that there will be a mixture of ratings in an assessment.

Preferably, the assessment starts at the lowest level of the CMM. If a lower level (3, say) of the CMM has not been fully institutionalized, higher levels need not be neglected. In the inventive process, it is not only possible, but preferable to work on several levels simultaneously. As an example, within the “Organization Process Focus” Key Process Area described within Level 3, a procedure supports the following:

If an appraisal form participant indicates that they are “fully” institutionalized” which is a rating of “7” in their implementation, then the assumption can be made that this key practice . . .
Rating 1: is known (they have heard about it)
Rating 2: is documented (e.g., either a handwritten procedure, deliverable, web page, online screen, etc.)
Rating 3: is being used by the project (It's not good enough to just have a deliverable documented it needs to be “up-to-date” and “put into action”!)
Rating 4: measurements are used to status the activities being performed for managing allocated requirements (one needs to be using the defined organizational measures from the SPD, and any other identified project-specific measures)
Rating 5: is being verified. Which is the first (1) step of institutionalization. Verifying implementation requires reviews by the Software Engineering Process Group (SEPG) and/or SQA.
Rating 6: is being maintained. Which is the second (2) step of institutionalization. Maintaining implies that training (e.g., formal and/or informal, work/support aids such as procedures are being promoted) is taking place surrounding this. Thus, even after those who originally defined them are gone, somebody will be able to take his/her place.
Rating 7: is being continuously improved. This final step (3) of institutionalization implies that the process has been in existence/used for at least six to twelve (6-12) months, and with the usage of both organizational and/or project-specific measures, improvements are being applied, as appropriate.

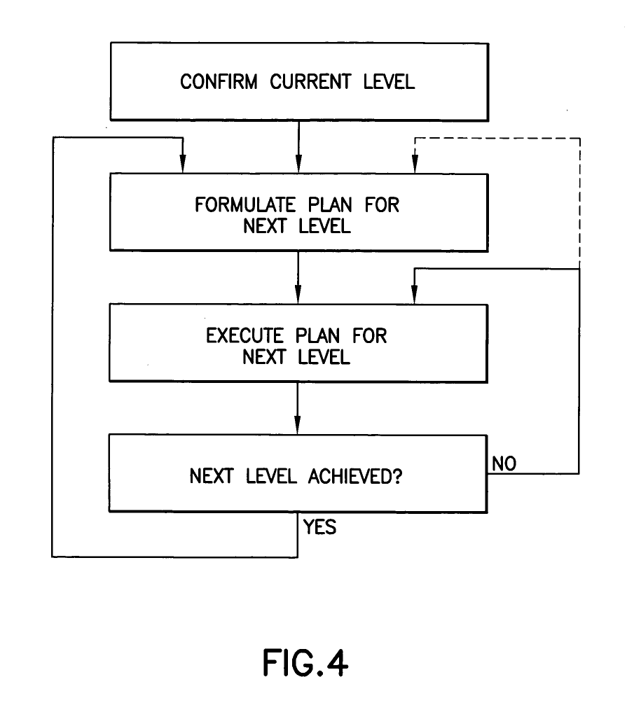

The software process is assessed periodically, and action plans are developed to address the assessment findings. FIG. 4 illustrates schematically an iterative procedure focusing on a single aspect of the software procedure. The dotted line on the right indicates that in some cases, it will be necessary to re-formulate the plan for the next level, in addition to persevering in the execution of the plan.

Preferably, the local SEPG will be called in to assist in the evaluation and/or improvement of the application of the organization's approved process to the particular project being assessed.

Practitioners in the art will note that an assessment does not simply review the CMM model, but rather looks at the organization's software process from a different perspective. For example, a rating of “4” according to the invention means that the process being assessed employs measurements to evaluate the status of the activities being performed by the development group. In contrast, the CMM introduces quantitative measurement in level 4. In a process as described here, a group that has achieved a rating of 4 will be using measurements from the start of a project.

Further, the first step of institutionalization, level 5, involves verifying, with the aid of the organization's SEPG, that the assessment level in question has been met. In addition, a rating of 6 in the inventive method means that training is used to institutionalize the process, though the CMM places training in its Level 3. This different placement reflects different understanding in the CMM and in the present system. In the CMM, training is used to teach users how to use the program; while according to the present process, training is used to reinforce the software process in the minds of the development team to the extent that it becomes second nature.

In operation, a form such as that shown in FIG. 1 may be used, whether on paper or on a computer screen. The leftmost column references the KPA in question. The second column from the left repeats the capsule definition of the KPA taken from the CMM. The third column references the element of the total process, any relevant document associated with that KPA, and the relevant sub-group that is responsible for that KPA. An evaluator, e.g. the Project Manager will distribute paper forms or set up an evaluation program for computer-operating the evaluation process. The participants, members of the development team and a representative from the SEPG will then proceed through the form, assigning a ranking to each KPA. The set of columns on the right serve to record the ratings. An example of a set of KPAs is set forth in Table III. The columns on the right have been removed from this example to improve the clarity of the presentation by using larger type.

The set of ratings from the individual assessors may be combined by simple averaging or by a weighted average, since not all KPAs will have equal weight in the assessment. Optionally, a roundtable meeting may be used to produce a consensus rating.

FIG. 1 reproduces the question that is asked for each KPA:
“To what level is the following key practice or activity being implemented within your project?”

A related question that is asked in other parts of the form is:
“To what level is the following key practice or activity being implemented within your organization?”

An example of a KPA capsule description is: “The project's defined software process is developed by tailoring the organization's standard software process according to a documented procedure”. The thrust of the question as applied to the foregoing is: How far along is the institutionalization of complying with a documented procedure for modification of the particular process applied within this organization—on a scale ranging from “Not Used” to “Fully Institutionalized”? There is a clear conceptual difference between asking the foregoing question and asking questions directed at the result of the process e.g. how well the software works, how timely was it, how close to budget, etc.

On the right of FIG. 1, there is a row of nine columns for the indication of the rating of that particular KPA; i.e. the answer to the question. That particular format is not essential for the practice of the process in its broader aspects and other formats, e.g. a single entry slot on a computer screen, a sliding arrow on a screen that the user moves with his mouse, etc.

The process followed is indicated graphically in FIG. 2, in which the assessment team evaluates the current status of the various KPAs. Having reached an assessment of the current status, the team or a sub-group formulates a plan to advance the level of the project to the next rating. That plan will usually include a number of sub-plans aimed at sub-groups within the team. The last step of documenting the procedure includes modifying existing procedures and plans, formulating new plans, etc.

Validation

Once the first level above the bottom has been reached, proper management requires some sort of review of the status of the level of maturity of the project—to validate whether it has advanced, held steady and become institutionalized, or even has regressed.

Preferably, the reviews are held periodically and/or when the project members feel that they have succeeded in advancing to the next level. The purpose of a periodic review is to fit the review result in with on-going management activities, e.g. an annual plan and incidentally to remind the project members that they are expected to be improving the level of maturity.

The term validate implicitly connotes a review by some one outside the project itself. The preceding material has described an assessment process that has the considerable advantage that it can be a self-assessment by the project members. Good management practice, however, is that an outside and preferably unbiased validation review is desirable.

If the process described earlier is followed, the validation process can be relatively short, because the previous process provides a solid foundation for the validation. It is perhaps useful to reiterate that the purpose of a validation review is to confirm and/or clarify the level of maturity of the project according to the CMM, not to decide if the project is cost-effective or otherwise review the management decision to embark on the project.

In summary, the validation process starts on the occurrence of a) a scheduled review because it has been a year (or other period) since the last review; b) a request by the project team, who feel that they have advanced to the next level; or c) a period (preferably less than a year) since the project was rated as having failed to satisfy the requirements of one or more KPAs.

Optionally, the SEPG offers pre-validation training/coaching as to how to improve the relevant aspect of the project. In the illustrative example, the offer may be rejected.

A review meeting is scheduled in which the assessors (preferably from the SEPG) will examine the self-ratings from the project team and selected deliverables.

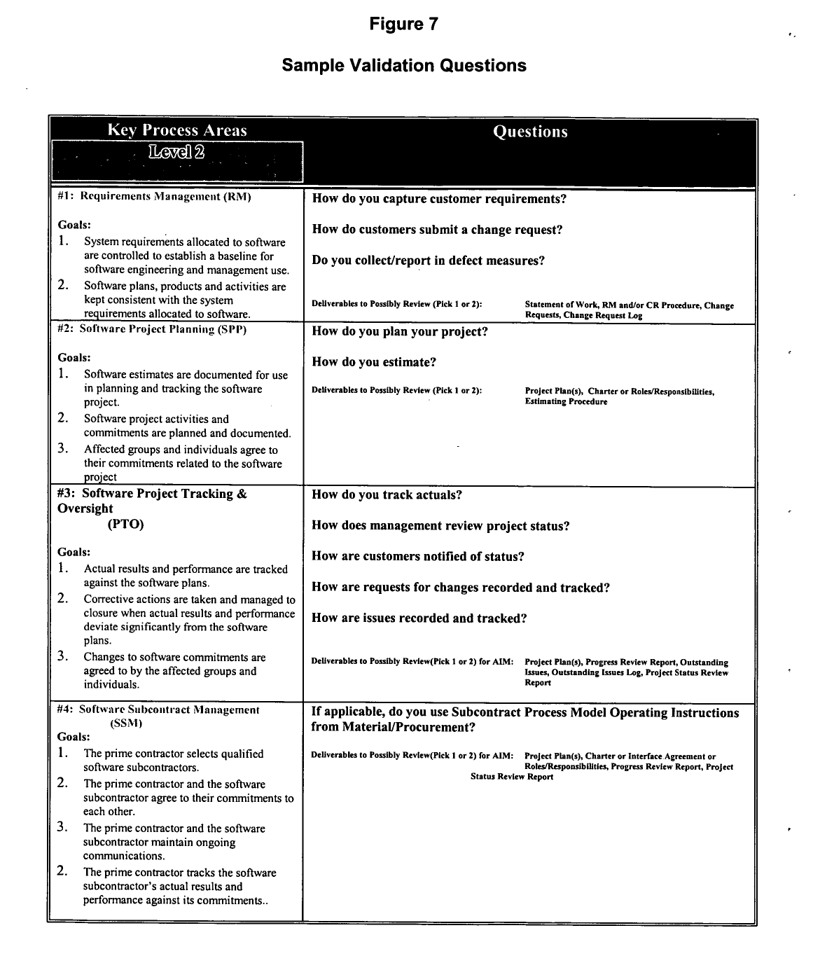

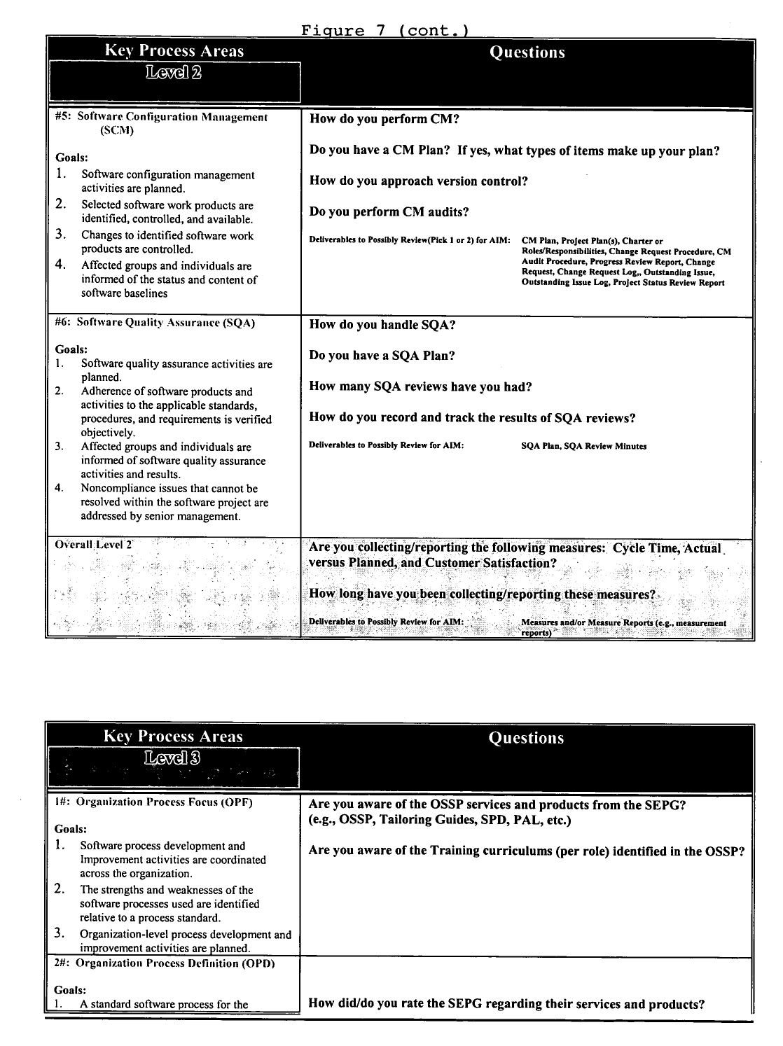

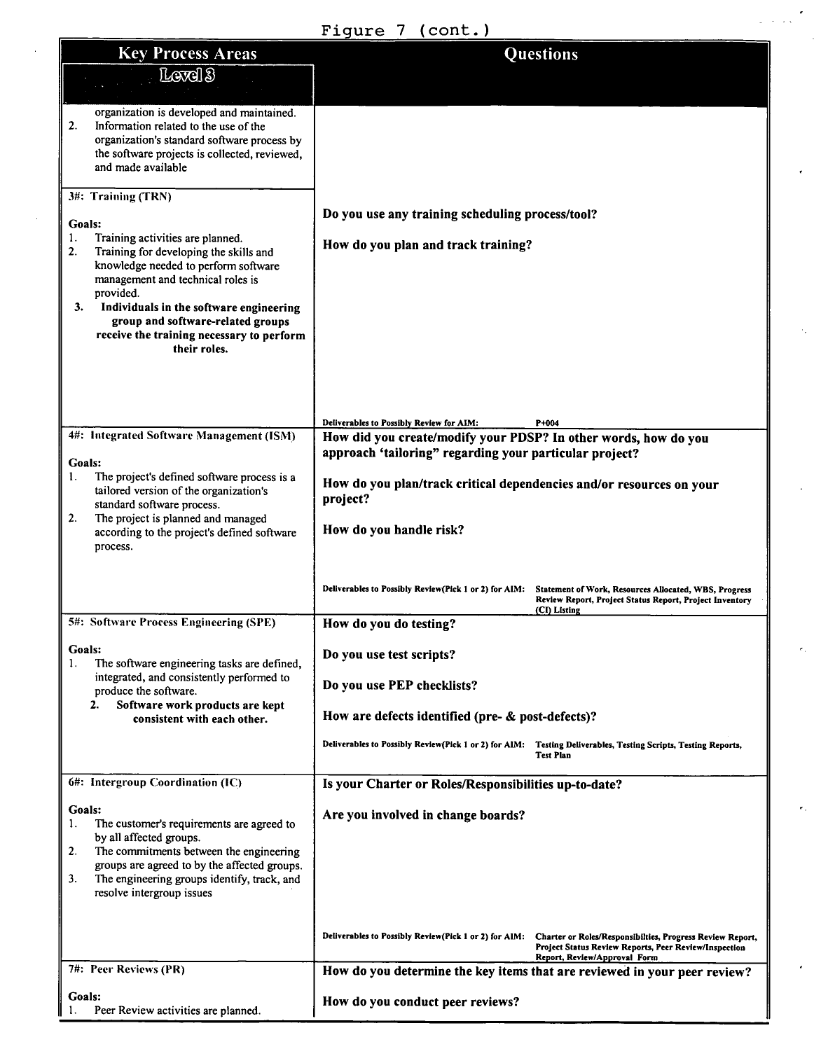

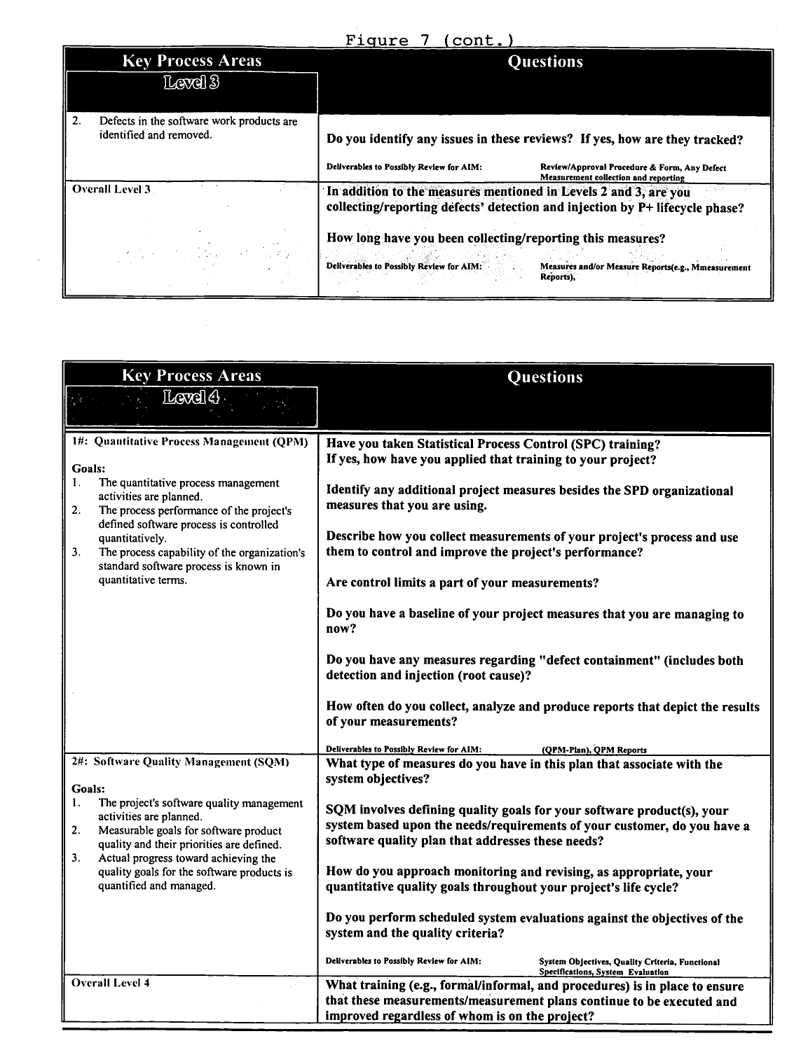

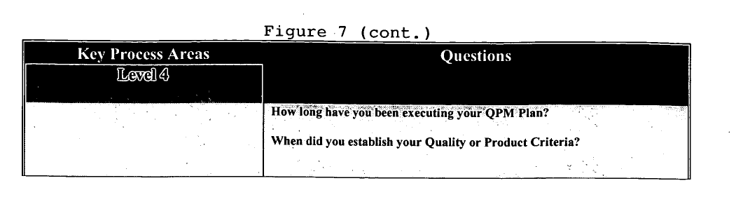

During the review meeting, the SEPG Analysts will review the self-assessment ratings and the deliverables and the KPA processes used in the project. The review should be sufficiently detailed that the analysts can reach a definite conclusion as to whether the relevant standard has been met. Preferably, the analysts will ask a set of questions along the lines of those in FIG. 7, in order to facilitate getting information out to be reviewed.

The Analysts will complete a report listing for each KPA in each level up to the level being validated reflecting the rating that the analysts have decided on, and strengths and weaknesses pertinent to that KPA and that level.

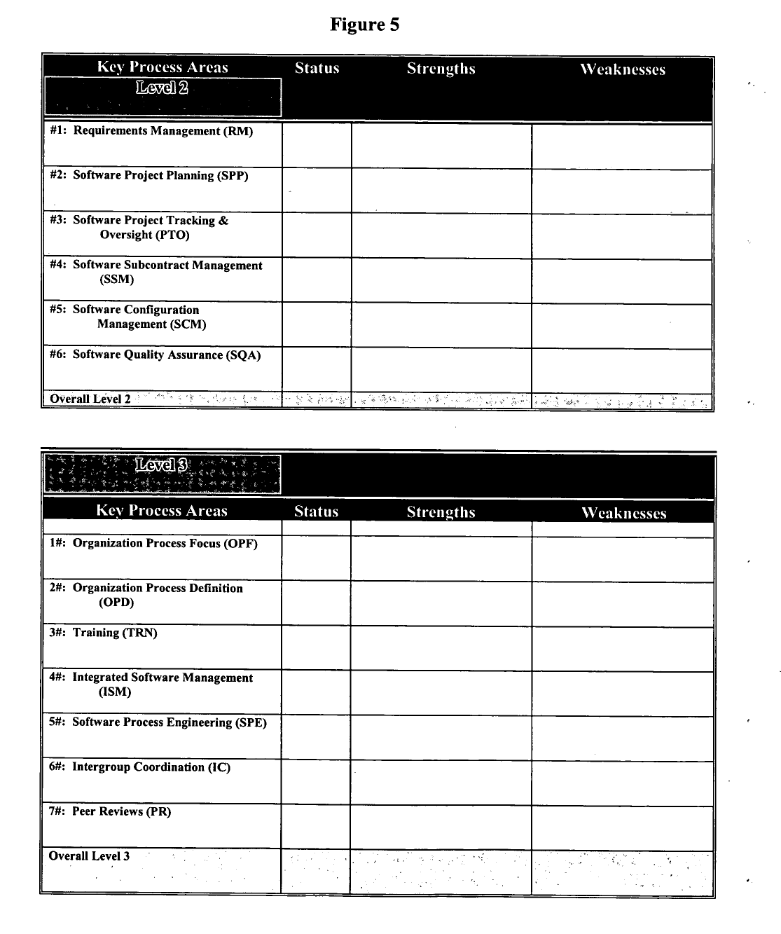

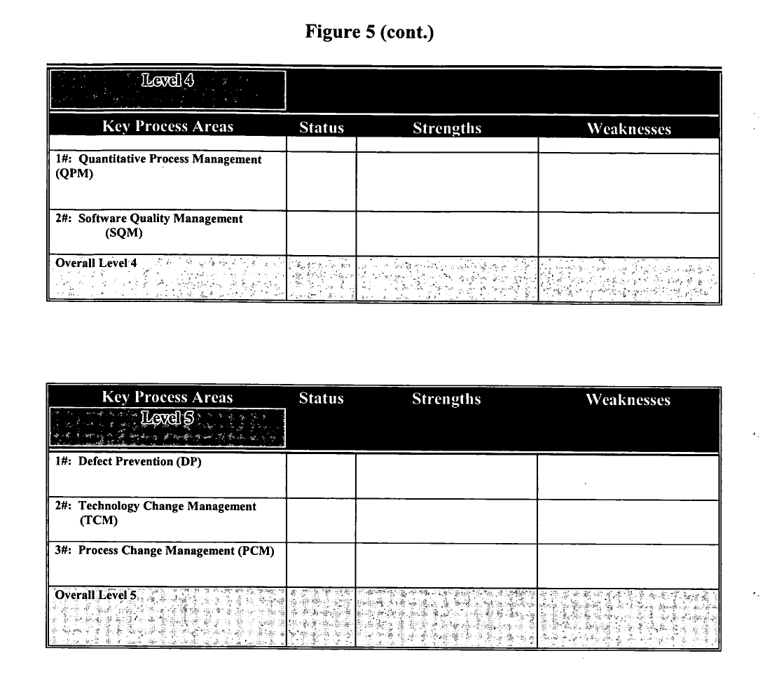

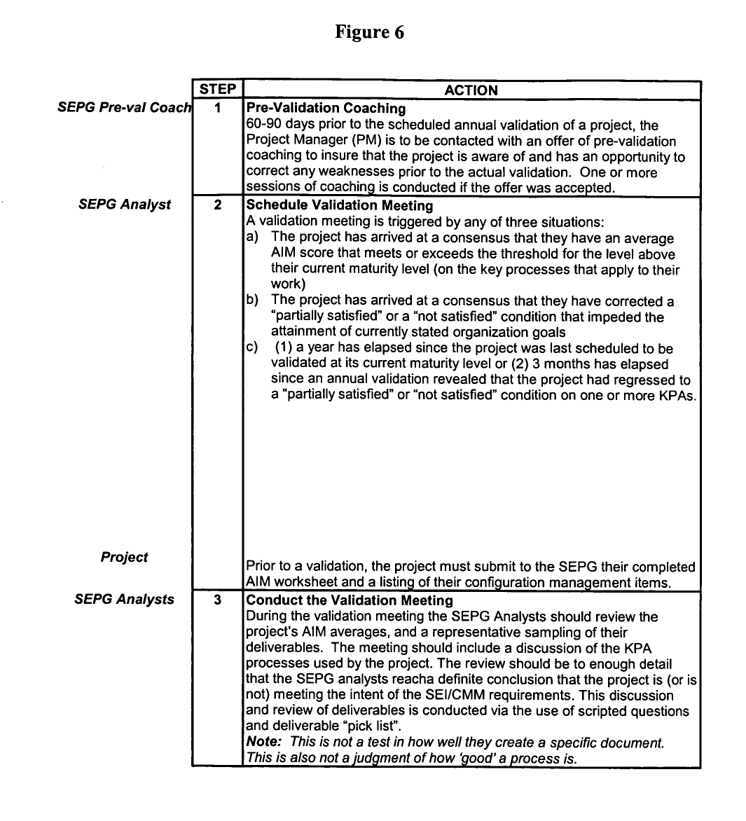

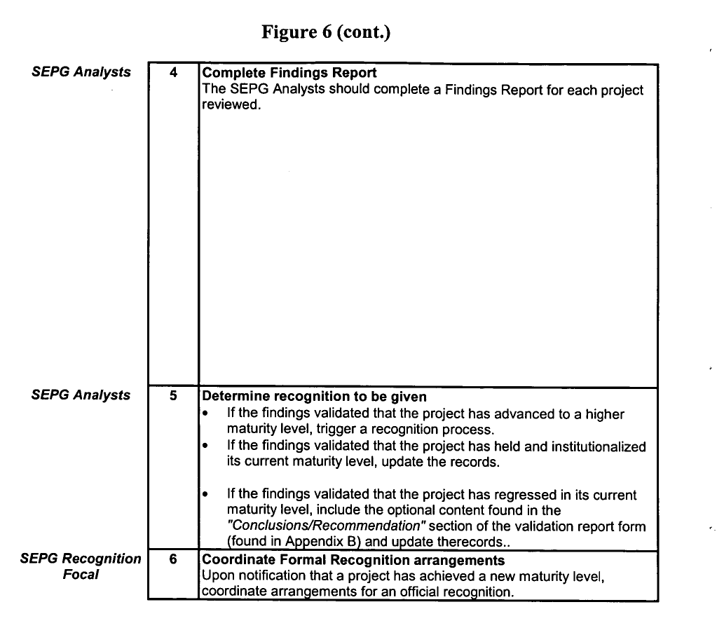

FIG. 5 illustrates an example of a recording sheet that may be useful in compiling a report on the level of achievement of the project team. On the left of the sheet is a list of the KPAs, with the next column for recording the status that the validation team finds (which is not necessarily the same as that of the project team). On the right, space is provided for a capsule notation of strengths and weaknesses pertinent to that KPA.

Since the validation process will not be performed until the project team has been practicing self-assessment for a while, it is expected that the validation and the questions in FIG. 7 and the conclusions in FIG. 5 will concentrate on the margin—i.e. those KPAs that were unsatisfactory at the last review or have otherwise been flagged as being the ones that the team is concentrating on.

Assuming that the validation is positive—i.e. that the Analysts agree that the project has reached the next level, (or corrected deficiencies), the preferred version of the process provides for recognition to the project team.

Illustratively, the focal person will arrange for a fairly senior manager to hand out certificates of accomplishment to team members. Optionally, the customers who have requested the particular improvement in question are invited to the award ceremony to reinforce the recognition of the project team.

If the validation reveals that the team has not improved (or has regressed) the validation process generates new data that permits a better focus on the steps to be taken to improve.

Those skilled in the art will appreciate that the evaluation may be carried out by manipulating symbols on a computer screen instead of checking a box on a paper form. The phrase manipulating symbols means, for purposes of the attached claims, checking a box on a computer display, clicking a mouse pointer on a “radio button” displayed on the screen, typing a number in a designated location on the screen, etc.

Although the invention has been described with respect to a single embodiment, those skilled in the art will appreciate that other embodiments may be constructed within the spirit and scope of the following claims.

TABLE I
DEFINITIONS

Allocated Requirements: The subset of the system requirements that are to be implemented
in the software components of the system.
Audit: An independent examination of a work product or set of work products to assess
compliance with specifications, standard, contractual agreements, etc.
CCB: Configuration Control Board
CMA: Configuration Management Audit
CM: Configuration Management
CMM: Capability Maturity Model. A description of the stages through which
organizations evolve as they define, implement, measure, control and improve their
software processes.
Configuration Item (CI) & Element (CE): An aggregation of hardware, software, or both,
that is designated for configuration management and treated as a single entity in the
configuration management process. A lower partitioning of the configuration item can be
performed. These lower entities are called configuration elements or CEs.
DP: Defect Prevention Level 5 Key Process Area. The purpose is to identify the cause
of defects and prevent them from recurring.
Documented Procedure: A written description of a course of action to be taken to perform
a given task.
Institutional/Institutionalization: The building of infrastructure and corporate culture that
support methods, practices and procedures so that they are continuously verified,
maintained and improved.
ISM: Integrated Software Management Level 3 Key Process Area. The purpose is to
integrate the software engineering and management activities into a coherent,
defined software process that is tailored from the organization's standard software
process (OSSP) and related process assets.
IC: Intergroup Coordination Level 3 Key Process Area. The purpose is to establish a
means for the software engineering group to participate actively with the other
engineering groups so the project is better able to satisfy the customer's needs
effectively and efficiently.
Key Practice: The infrastructures and activities that contribute most to the effective
implementation and institutionalization of a key process area. There are key practices in
the following common features: commitment to perform ability to perform activities
performed measurement and analysis verifying implementation.
KPA: Key Process Area
OPD: Organization Process Definition Level 3 Key Process Area. The purpose is to
develop and maintain a usable set of software process assets that improve process
performance across the projects and provide a basis for cumulative, long-term
benefits to the organization. Involves developing and maintaining the
organization's standard software process (OSSP), along with related process assets,
such as software life cycles (SLC), tailoring guidelines, organization's software
process database (SPD), and a library of software process-related documentation
(PAL).
OPF: Organization Process Focus Level 3 Key Process Area. The purpose is to establish
the organizational responsibility for software process activities that improve the
organization's overall software process capability. Involves developing and
maintaining an understanding of the organization's and projects” software
processes and coordinating the activities to assess, develop, maintain, and improves
these processes.
OSSP: Organization Standard Software Process. An asset which identified software
process assets and their related process elements. The OSSP points to other
assets such as Tailoring, SPD, SLC, PAL and Training.
PDSP: Project's Defined Software Process. The definition of the software process used
by a project. It is developed by tailoring the OSSP to fit the specific
characteristics of the project.
PR: Peer Reviews Level 3 Key Process Area. A review of a software work product,
performed according to defined procedures, by peers of the producers of the
product for the purpose of identifying defects and improvements.
PAL: Process Asset Library (PAL): A library where “best practices” used on past
projects are stored. In general, the PAL contains any documents that can be used
as models or examples for future projects.
PCM: Process Change Management Level 5 Key Process Area. The purpose is to
continually improve the software processes used in the organization with the intent
of improving software quality, increasing productivity, and decreasing the cycle
time for product development.
PM: Project Manager: The role with total responsibility for all the software activities
for a project. The Project Manager is the individual who leads the software
engineering group (project team) in terms of planning, controlling and tracking the
building of a software system.
POC: Planning, Organizing and Controlling
PTO: Software Project Tracking and Oversight Level 2 Key Process Area. To provide
adequate visibility into actual progress so that management can take corrective
actions when the software project's performance deviates significantly from the
software plans. Involves tracking and reviewing the software accomplishments and
results against documented estimates, commitments, and plans, and adjusting these
plans based on the actual accomplishments and results.
QPM: Quantitative Process Management Level 4 Key Process Area. Involves
establishing goals for the performance of the project's defined software process
(PDSP), taking measurements of the process performance, analyzing these
measurements, and making adjustments to maintain process performance within
acceptable limits.
RM: Requirements Management Level 2 Key Process Area. Involves establishing and
maintaining an agreement with the customer of the requirements for the software
project. The agreement forms the basis for estimating, planning, performing, and
tracking the software project's activities throughout the software life cycle.
R&R: Roles & Responsibilities A project management deliverable that describes the
people and/or working groups assigned in supporting the software project. This
charter deliverable delineates the assigned responsibility along with the listing of
contacts for each team member or group.
SCM: Software Configuration Management Level 2 Key Process Area. Purpose is to
establish and maintain the integrity of the products of the software project
throughout the project's software life cycle. Involves identifying the configuration
of the software at given points in time, controlling changes to the configuration,
and maintaining the integrity and traceability of the configuration the software life
cycle.
SEG: Software Engineering Group The part of the Project Team that delivers software to
the project. This includes, but is not limited to: System Manager, Project
Manager, Business Analysts, IS Analysts, SQE Focals, CM Focals.
SEI: Software Engineering Institute Developer/owner of the Capability Maturity Model.
SEPG: Software Engineering Process Group This group maintains, documents and
develops the various processes associated with software development, as
distinguished from the group responsible for creating the software and will
be responsible in facilitating the interim assessments as requested or
required (for software accreditation).
SEPG Recognition Focal SEPG analyst designated as focal to coordinate official
recognition in IS staff meetings of projects validated as
achieving the targeted level of performance.
SEPG Pre-Validation Coach SEPG analyst designated as focal to assist projects prior to
their annual validation by providing an opportunity to >preview= and address possible
weaknesses beforehand.
SEPG: Office Administrator The office administrator assigned to the SEPG organization.
SLC: Software Life Cycle The period of time that begins when a software product is
conceived and ends when the software is no longer available for use.
Software Process: A set of activities, methods, practices, and transformations that people
use to develop and maintain software and the associated products. (e.g., project plans,
design documents, code, test cases, and user manuals).
Software Process Assessment: An appraisal by a trained team of software professionals to
determine the state of an organization's current software process, to determine the high-
priority software process-related issues facing an organization, and to obtain the
organizational support for software process improvement.
SPD: Software Process Database A database established to collect and make available
data on the OSSP.
SPE: Software Product Engineering Level 3 Key Process Area. The purpose of SPE is to
consistently perform a well-defined engineering process that integrates all the
software engineering activities to produce correct, consistent software products
effectively and efficiently. This includes using a project's defined software process
to analyze system requirements, develop the software architecture, design the
software, implement the software in the code, and test the software to verify that it
satisfies the specified requirements.
SPP: Software Project Planning Level 2 Key Process Area. To establish reasonable
plans for performing the software engineering activities and for managing the
software project.
SSM: Software Subcontract Management Level 2 Key Process Area. The purpose is to
select qualified software subcontractors and manage them effectively. Involves
selecting a software subcontractor, establishing commitments with the
subcontractor, and tracking and reviewing the subcontractor's performance and
results.
SQA: Software Quality Assurance Level 2 Key Process Area. (1) A planned and
systematic pattern of all actions necessary to provide adequate confidence that a
software work product conforms to established technical requirements. (2) A set of
activities designed to evaluate the process by which software work products are
developed and/or maintained.
SQM: Software Quality Management Level 4 Key Process Area. Involves defining
quality goals for the software products, establishing plans to achieve these goals,
monitoring and adjusting the software plans, software work products, activities and
quality goals to satisfy the needs and desires of the customer for high-quality
products.
SOW: Statement of Work This project management deliverable clearly defines the project
manager's assignment and the environment in which the project will be carried out.
It defines the context, purpose, objectives of the project, scope interfaces to others,
project organization, outlines major constraints and assumptions, the project plan
and budget, critical success factors, and impacts and risks to the project and
organization.
SWEP: Software Engineering Process
Tailoring: The set of related elements that focus on modifying a process, standard, or
procedure to better match process or product requirements.
TCM: Technology Change Management A Level 5 Key Process Area. The purpose is to
identify new technologies (i.e., tools, methods, and processes) and track them into
the organization in an orderly manner.
TRN: Training Level 3 Key Process Area. The purpose of training is to develop the skills
and knowledge of individuals so they can perform their roles effectively and
efficiently.

1. A method of validating the level of development of a software management process implementing a Capability Maturity Model CMM in a project carried out by a project team, comprising:
a) Selecting an ith level of the CMM model;
b) Selecting a jth sub-level in said ith level;
c) Selecting a Key Process Area KPA in said jth sub-level;
d) Reviewing the rating assessing the level of maturity in said project of said KPA of said jth sub-level that was assigned by the project team and a sample of deliverables associated with said KPA of said jth sub-level;
e) Recording a rating of said jth sub-level; and
f) Repeating elements a) through e) until all KPAs in ith level of the CMM model have been reviewed and corresponding ratings have been recorded.

2. A method according to claim 1, further comprising categorizing the results in one of three categories: advanced, institutionalized and regressed.

3. A method according to claim 1, in which reviewing the rating is carried out by a validation team.

4. A method according to claim 3, in which said validation team is composed of members of a Software Engineering Process Group SEPG.

5. A method according to claim 3, in which said validation is carried at least in part through a structured set of questions organized with the structure of the KPAs.

6. A method according to claim 5, in which said structured set of questions concentrate on the actual operations practiced within the project.

7. A method according to claim 6, further comprising examining a set of deliverables correlated with said structured set of questions to demonstrate the actual operations practiced within the project.

8. A method according to claim 1, further comprising asking a set of validation questions.

9. A method according to claim 8, in which said set of validation questions comprises at least one question for each sub-level.

10. A method according to claim 8, further comprising examining a set of deliverables for each sub-level.

11. A method according to claim 10, in which said set of validation questions comprises at least one question for each sub-level that is correlated with said set of deliverables.

12. A method of validating the status of a software project comprising:
scheduling a validation meeting between a validation team and a project team upon the occurrence of at least one of:
a) expiration of a first standard review period since a previous review resulted in an unsatisfactory result, or
b) expiration of a second standard review period since a previous review resulted in a satisfactory result, the first review period being shorter than the second review period; or
c) conclusion by the project team that they have improved the status of their project;
conducting the validation meeting by reviewing a set of deliverables demonstrative of the status of the project and correlated with a Capability Maturity Model CMM and by a series of structure questions tracking the structure of the CMM; and
completion by the validation team of a findings report summarizing the status of the project.

13. A method according to claim 12, further comprising a recognition process after the issue of a positive findings report.

14. A method according to claim 12, further comprising a training session before the validation meeting to improve the project team's ability to meet the validation requirements.

15. A method according to claim 13, further comprising a training session before the validation meeting to improve the project team's ability to meet the validation requirements.

16. A method of improving the application of a software management process implementing a Capability Maturity Model CMM in a project, comprising:
a) Selecting an ith level of the CMM model;
b) Selecting a jth sub-level in said ith level;
c) Selecting a Key Process Area KPA in said jth sub-level;
d) Assigning a rating assessing the level of maturity in said project of said KPA;
e) formulating and documenting a plan to improve said rating number;
f) Repeating elements a) through e) until all KPAs in the CMM have been assessed and corresponding plans have been formulated and documented; and
g) periodically validating the status of the process by:
h) Selecting an mth level of the CMM model;
i) Selecting a nth sub-level in said mth level;
j) Selecting a KPA in said nth sub-level;
k) Reviewing the rating assessing the level of maturity in said project of said KPA of said nth sub-level that was assigned by the project team and a sample of deliverables associated with said KPA of said nth sub-level;
l) Recording a rating of said nth sub-level; and
m) Repeating elements h) through l) until all KPAs in said mth level of the CMM model have been reviewed and corresponding ratings have been recorded.

17. A method according to claim 16, further comprising categorizing the results in one of three categories: advanced, institutionalized and regressed.

18. A method according to claim 16, in which reviewing the rating is carried out by a validation team.

19. A method according to claim 18, in which said validation team is composed of members of a Software Engineering Process Group SEPG.

20. A method according to claim 18, in which said validation is carried at least in part through a structured set of questions organized with the structure of the AIM.

21. A method according to claim 20, in which said structured set of questions concentrate on the actual operations practiced within the project.

22. A method according to claim 21, further comprising examining a set of deliverables correlated with said structured set of questions to demonstrate the actual operations practiced within the project.

23. An article of manufacture comprising a program storage medium readable by a computer, the medium embodying instructions executable by the computer for validating the level of development of a software management process implementing a Capability Maturity Model CMM to a project carried out by a project team, comprising:
a) Selecting an ith level of the CMM model;
b) Selecting a jth sub-level in said ith level;
c) Selecting a Key Process Area KPA in said jth sub-level;
d) Reviewing the rating assessing the level of maturity in said project of said KPA of said jth sub-level that was assigned by the project team and a sample of deliverables associated with said KPA of said jth sub-level;
e) Recording a rating of said jth sub-level; and
f) Repeating elements a) through e) until all KPAs in ith level of the CMM model have been reviewed and corresponding ratings have been recorded.

24. An article of manufacture according to claim 23, further comprising categorizing the results in one of three categories: advanced, institutionalized and regressed.

25. An article of manufacture according to claim 24, in which said validation is carried at least in part through a structured set of questions organized with the structure of the AIM.

26. An article of manufacture according to claim 25, in which said structured set of questions concentrate on the actual operations practiced within the project.

27. An article of manufacture according to claim 26, in which said set of validation questions comprises at least one question for each sub-level.

28. An article of manufacture according to claim 27, in which said set of validation questions comprises at least one question for each sub-level that is correlated with said set of deliverables.
